(19) United States
(12) Patent Application Publication
(10) Pub. No.: US 2013/0077342 A1
(43) Pub. Date: Mar. 28, 2013

(54) DISPLAY DEVICE

(71) Applicants: Tsuyoshi Hioki, Tokyo (JP); Yutaka Nakai, Kanagawa-ken (JP)

(72) Inventors: Tsuyoshi Hioki, Tokyo (JP); Yutaka Nakai, Kanagawa-ken (JP)

(73) Assignee: KABUSHIKI KAISHA TOSHIBA, Tokyo (JP)

(21) Appl. No.: 13/525,473

(22) Filed: Jun. 18, 2012

(30) Foreign Application Priority Data
Sep. 27, 2011 (JP) 2011-210316

(51) Int. Cl. F21V 8/00

(52) U.S. Cl. 362/602

(57) ABSTRACT

According to one embodiment, a display device includes light emitting units, light guides, light extraction units, and a light receiver. The light emitting unit emits a light. The light guide guides the light. The light guide includes a side surface, and first and second ends. The side surface extends along a first direction. The light guides are disposed in a second direction intersecting the first direction. The light extraction unit faces the side surface and emits a light guided through the light guide toward an outside. The light receiver faces the first end and includes a photoelectric converter. The photoelectric converter receives a light which is guided through the light guide and emitted from the first end.

### CROSS-REFERENCE TO RELATED APPLICATIONS

This application is based upon and claims the benefit of priority from the prior Japanese Patent Application No. 2011-210316, filed on Sep. 27, 2011; the entire contents of which are incorporated herein by reference.

### FIELD

Embodiments described herein relate generally to a display device.

### BACKGROUND

In display devices that visualize an image signal and display it as image information, further improvements in performance and functionality are required. For example, there is a configuration in which an organic EL display device is provided with a solar cell on its display surface to obtain a power generation function in addition to the function of performing the display operation.

### BRIEF DESCRIPTION OF THE DRAWINGS

FIG. 1A and FIG. 1B are schematic views showing a display device according to a first embodiment;

FIG. 2 is a schematic cross-sectional view showing a part of the display device according to the first embodiment;

FIG. 3 is a schematic view showing one operation of the display device according to the first embodiment;

FIG. 4 is a schematic view showing another operation of the display device according to the first embodiment;

FIG. 5 is a schematic plan view showing an operation of the display device according to the first embodiment;

FIG. 6 is a schematic plan view showing another operation of the display device according to the first embodiment;

FIG. 7 is a schematic view showing a part of the display device according to the first embodiment;

FIG. 8A and FIG. 8B are schematic views showing the configuration and operations of a part of the display device according the first embodiment;

FIG. 9 is a schematic cross-sectional view showing another display device according to the first embodiment;

FIG. 10 is a schematic view showing one operation of the another display device according to the first embodiment;

FIG. 11 is a schematic view showing another operation of the another display device according to the first embodiment;

FIG. 12A and FIG. 12B are schematic views showing operations of the display device according to the first embodiment;

FIG. 13 is a schematic cross-sectional view showing a part of another display device according to the first embodiment;

FIG. 14 is a schematic cross-sectional view showing the configuration and one operation of a display device according to a second embodiment;

FIG. 15 is a schematic view showing another operation of the display device according to the second embodiment; and

FIG. 16 is a schematic cross-sectional view showing the configuration and operations of a display device according to a third embodiment.

### DETAILED DESCRIPTION

According to one embodiment, a display device includes a plurality of light emitting units, a plurality of light guides, a plurality of light extraction units, and a light receiver. The light emitting units emit a light. The light guides guide the light emitted from the light emitting units. Each of the light guides includes a side surface, a first end, and a second end. The side surface extends along a first direction. The light guides are disposed in a second direction intersecting the first direction. Each of the light extraction units faces the side surface of the light guides. Each of the light extraction units is capable of selectively emitting a light which is guided through the light guides toward an outside of the light guides. The light receiver faces the first end and includes a photoelectric converter. The photoelectric converter is configured to receive a light which is guided through each of the light guides and is emitted from the first end.

Various embodiments will be described hereinafter with reference to the accompanying drawings.

The drawings are schematic or conceptual; and the proportions of sizes among portions, etc. are not necessarily the same as the actual values thereof. Further, the dimensions and proportions may be illustrated differently among drawings, even for identical portions.

In the specification of this application and the drawings, components similar to those described in regard to a drawing thereinabove are marked with the same reference numerals, and a detailed description is omitted as appropriate.

### First Embodiment

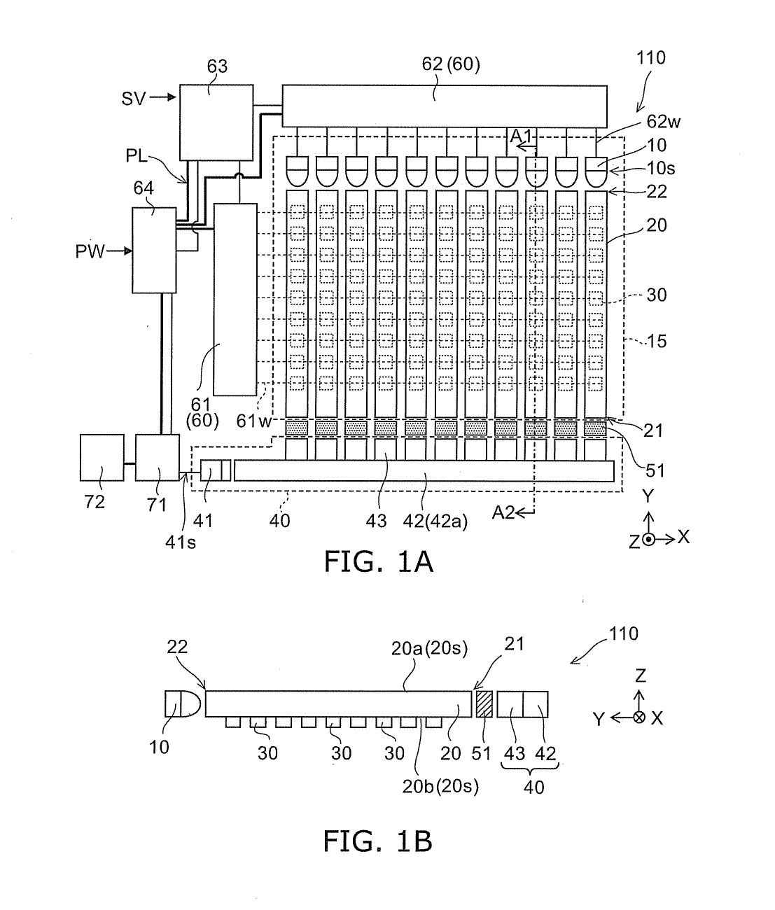

FIG. 1A and FIG. 1B are schematic views illustrating the configuration of a display device according to a first embodiment.

FIG. 1A is a plan view. FIG. 1B is a cross-sectional view taken along line A1-A2 of FIG. 1A. As shown in FIG. 1A, a display device 110 according to the embodiment includes a plurality of light emitting units 10s, a plurality of light guides 20, a plurality of light extraction units 30, and a light receiver 40.

The plurality of light emitting units 10s emit light. The light has a wavelength (400 nm or more and 760 nm or less). The plurality of light guides 20 guide the light emitted from the light emitting units 10s. Each of the plurality of light guides 20 extends in the Y-axis direction (a first direction). The plurality of light guides 20 are disposed in a second direction intersecting the first direction. For example, the second direction is perpendicular to the first direction. That is, the plurality of light guides 20 are disposed in the X-axis direction which is perpendicular to the Y-axis direction. The direction perpendicular to the Y-axis direction and perpendicular to the X-axis direction is defined as the Z-axis direction (a third direction). As shown in FIG. 1B, the light guide 20 includes a side surface 20s, a first end 21, and a second end 22. The side surface 20s extends along the Y-axis direction. The first end 21 is one end in the Y-axis direction of the light guide 20. The second end 22 is the other end in the Y-axis direction of the light guide 20.

The side surface 20s includes, for example, one side surface in the Z-axis direction (for the sake of convenience, referred to as an upper side surface 20a) of the light guide 20 and the other side surface in the Z-axis direction (for the sake of convenience, referred to as a lower side surface 20b) of the light guide 20.

Each of the plurality of light extraction units 30 faces the side surface 20s (in the example, the lower side surface 20b) of the light guide 20.

In the specification of this application, “face” includes the case of opposing directly and also the case of opposing via another component.

The light extraction unit 30 causes the light guided through the light guide 20 to be emitted from the side surface 20s (in the example, the upper side surface 20a) toward the outside of the light guide 20. The light extraction unit 30 can perform the operation of extracting the light guided through the light guide 20 selectively and locally.

For example, the light extraction unit 30 causes the light guided through the light guide 20 to be emitted from the light guide 20 in the Z-axis direction. The light emitted from the light guide 20 does not need to be a light beam strictly parallel to the Z-axis direction but may have a spread. Furthermore, the light emitted from the light guide 20 may be inclined with respect to the Z-axis direction.

For example, the side surface (in the example, the lower side surface 20b) faced by the light extraction unit 30 is the surface on the opposite side to the surface (in the example, the upper side surface 20a) from which light is emitted.

A plurality of light extraction units 30 are provided in one light guide 20. The plurality of light extraction units 30 facing the side surface 20s of one light guide 20 are disposed along the Y-axis direction. The plurality of light extraction units 30 are disposed along the Y-axis direction and face the side surface 20s (e.g. the lower side surface 20b) of each of the plurality of light guides 20.

As shown in FIG. 1A and FIG. 1B, the light receiver 40 faces the first end 21. The light receiver 40 includes a photoelectric conversion unit 41. The photoelectric conversion unit 41 receives the light guided through the plurality of light guides 20 and emitted from the first ends 21.

In the example, the light receiver 40 further includes a light collection guide 42. The light collection guide 42 guides the light emitted from each of the first ends 21 of the plurality of light guides 20 and causes the light to enter the photoelectric conversion unit 41. The light collection guide 42 includes a portion 42a extending along the X-axis direction. The photoelectric conversion unit 41 is disposed at the end of the light collection guide 42, for example.

In the example, the light receiver 40 further includes optical path changing units 43. The optical path changing unit 43 faces each of the first ends 21 of the plurality of light guides 20. The optical path changing unit 43 changes the optical path of the light emitted from each of the first ends 21 and causes the light to enter the light collection guide 42. The optical path changing unit 43 changes the optical path from the waveguide direction in the light guide 20 (the Y-axis direction) to the waveguide direction in the light collection guide 42 (the X-axis direction). Examples of the optical path changing unit 43 are described later.

Although the configuration of the example is designed to reduce the number of photoelectric conversion units 41, the light collection guide 42 and the optical path changing unit 43 mentioned above are provided as necessary and may be omitted. For example, a configuration may be used in which the photoelectric conversion unit 41 is provided to face each of the first ends 21 of the light guides 20, and a controller 71 described later and each photoelectric conversion unit 41 are electrically connected.

In the example, the light emitting unit 10s is apposed to the second end 22. The light emitting unit 10s causes light to enter the light guide 20 from the second end 22. In the example, the light emitting unit 10s faces the end surface of the second end 22, and injects light into the light guide 20 from the end surface of the second end 22. The light emitting unit 10s is optically connected to the light guide 20 at the end surface of the second end 22, for example. However, the embodiment is not limited thereto, and the light emitting unit 10s may face, for example, a part of the side surface 20s on the second end 22 side. Furthermore, the light emitting unit 10s may be provided near the side of the first end 21 (the end on the side where the light receiver 40 is disposed).

In the example, a light source 10 is used for each of the plurality of light emitting units 10s. Each of the plurality of light sources 10 is juxtaposed to each of the plurality of light guides 20. However, the embodiment is not limited thereto. For example, a configuration is possible in which one light source 10 is provided, the light emitted from the light source 10 is controlled by an optical switch (not shown) to be emitted from a plurality of light emitting units (serving as the light emitting units 10s), and the light enters each of the plurality of light guides 20. In the following, an example is described in which the light source 10 is used as the light emitting unit 10s.

A display unit 15 is provided in the display device 110. The display unit 15 includes the plurality of light emitting units 10s (the light sources 10), the plurality of light guides 20, and the plurality of light extraction units 30. A plurality of pixels are provided in the display unit 15. One pixel corresponds to one light extraction unit 30. For example, M (M being an integer of 2 or more) light guides 20 are provided, and N (N being an integer of 2 or more) light extraction units 30 are provided for one light guide 20. The display unit 15 includes pixels arranged in a matrix configuration of M×N. Although

FIG. 1A illustrates an example of M=11 and N=9 for easier viewing of the drawing, M and N are arbitrary in the embodiment. Regions where the plurality of light guides 20 and the plurality of light extraction units 30 face each other form display regions in which pixels are arranged.

The display device 110 may further include a scan driver 61 and a light source driver 62. The scan driver 61 is connected to the plurality of light extraction units 30 via interconnections (scan lines 61w). The scan driver 61 supplies the plurality of light extraction units 30 with a signal for driving the light extraction units 30. The light source driver 62 is connected to the plurality of light sources 10 via light source interconnections 62w. The light source driver 62 supplies the plurality of light sources 10 with a signal (including a current) for driving the light sources 10.

A circuit unit 60 is provided in the display device 110. The circuit unit 60 supplies an electric signal to at least one of the light emitting units 10s (the light source 10) and the light extraction unit 30. The circuit unit 60 includes at least one of the scan driver 61 and the light source driver 62.

The display device 110 may further include an image processor 63. A video signal SV is supplied to the image processor 63. The image processor 63 supplies the scan driver 61 with a signal for scanning. The image processor 63 supplies the light source driver 62 with a signal for light emitting. The signal for scanning and the signal for driving the light source 10 are produced based on the video signal SV.

The display device 110 may further include a power supply 64. An electric power PW is supplied to the power supply 64. The power supply 64 supplies an electricity to the scan driver 61, the light source driver 62, and the image processor 63 via power supply system interconnections PL.

The display device 110 further includes an electricity storage unit 72 and a controller 71. The photoelectric conversion unit 41 converts at least a part of the light received by the photoelectric conversion unit 41 into electrical energy.

The electricity storage unit 72 stores at least a part of the electrical energy. The controller 71 controls the supply of the electrical energy obtained in the photoelectric conversion unit to the electricity storage unit 72. Furthermore, the controller 71 controls the supply of the electrical energy stored in the electricity storage unit 72 to the power supply 64. That is, the controller 71 controls the supply of electrical energy from the photoelectric conversion unit 41 to the electricity storage unit 72 and the extraction of electrical energy from the electricity storage unit 72. The controller 71 is connected to the power supply 64, for example. The power supply 64 supplies a current to the controller 71, for example. At least a part of the electrical energy obtained by the photoelectric conversion unit 41 converting the light received by the photoelectric unit 41 can be supplied to the power supply 64, for example.

The photoelectric conversion unit 41 converts the light guided through the light guide 20 to produce an electrical output line 41s, for example. The output 41s is supplied to the controller 71.

In the example, the display device 110 further includes a first reflector 51. The first reflector 51 is provided between each of the first ends 21 of the plurality of light guides 20 and the light receiver 40. Specifically, the first reflector 51 is provided between each of the end surfaces of the first ends 21 and the light receiver 40. The light reflectance of the first reflector 51 is variable. For example, the first reflector 51 has a reflection state and a transmission state. The reflectance of the first reflector 51 in the reflection state is higher than the reflectance of the first reflector 51 in the transmission state.

The transmittance of the first reflector 51 in the transmission state is higher than the transmittance of the first reflector 51 in the reflection state.

The first reflector 51 can perform the operation of reflecting the light incident on the first reflector 51 (a reflection operation) and the operation of transmitting the light incident on the first reflector 51 (a transmission operation). For example, the first reflectors 51 can perform the operation of reflecting the light emitted from each of the first ends 21 and causing the light to enter the plurality of light guides 20 and the operation of transmitting the light emitted from each of the first ends 21 and causing the light to enter the light receiver 40. In the first reflector 51, the reflection operation and the transmission operation can be performed to be switched to each other. The light guide 20 is, for example, optically connected to the light receiver 40 via the first reflector 51. Examples of the first reflector 51 are described later.

The plurality of light guides 20 are optically connected to the light collection guide 42 via the first reflectors 51 and the optical path changing units 43. The display device 110 can perform, for example, a display operation by the light source 10, the light guide 20, and the light extraction unit 30 and a power generation operation by the light guide 20 and the light receiver 40. The display device 110 is, for example, a display device having a power generation function.

A material transmissive to visible light such as a resin and glass, for example, is used for the light guide 20. The light guide 20 may have a column or fiber shape extending in the Y-axis direction. A semiconductor light emitting device such as an LED, for example, may be used as the light source 10. A material transmissive to visible light such as a resin and glass, for example, is used for the light collection guide 42 of the light receiver 40. A device using a semiconductor, for example, is used as the photoelectric conversion unit 41.

A liquid crystal device, a MEMS (micro-electro-mechanical system) device, etc., for example, are used as the light extraction unit 30. However, the embodiment is not limited thereto, and any device that can change the light guide state of the light guide 20 (for example, allow switching between a total reflection state and a non-total reflection state) may be used as the light extraction unit 30.

An example of the light extraction unit 30 will now be described.

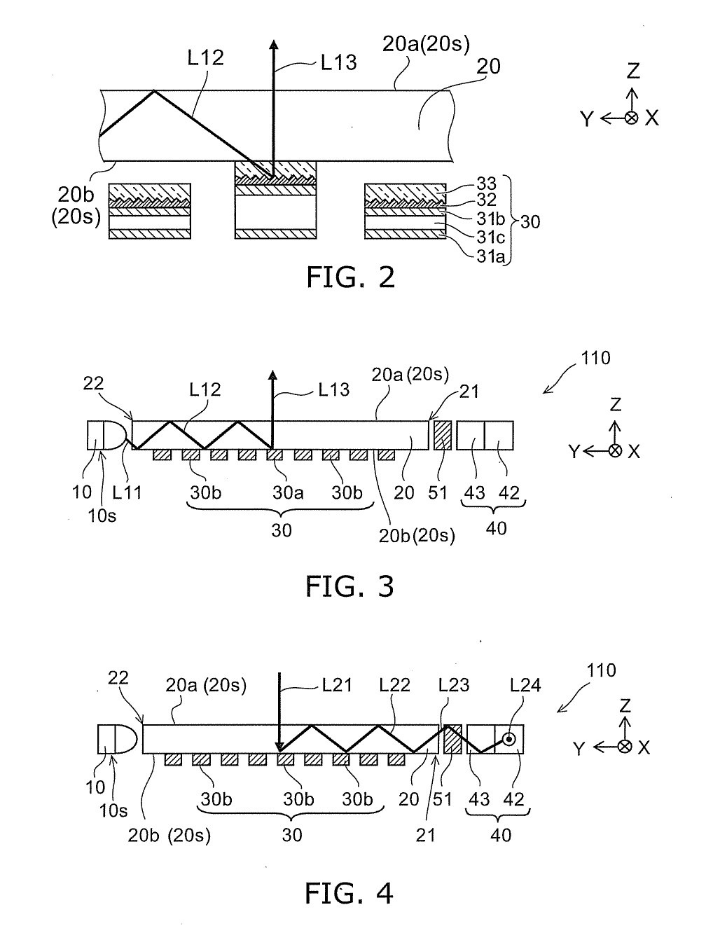

FIG. 2 is a schematic cross-sectional view illustrating the configuration of a part of the display device according to the first embodiment. FIG. 2 illustrates a part of the cross section taken along line A1-A2 of FIG. 1A, and illustrates the configuration of the light extraction unit 30 along with a part of the light guide 20.

As shown in FIG. 2, in the example, the light extraction unit 30 includes a first electrode layer 31a, a second electrode layer 31b, a reflection layer 32, and a light extraction layer 33. The second electrode layer 31b is disposed between the first electrode layer 31a and the light extraction layer 33. The reflection layer 32 is disposed between the second electrode layer 31b and the light extraction layer 33. A displacement layer 31c is provided between the first electrode layer 31a and the second electrode layer 31b. The distance between the first electrode layer 31a and the second electrode layer 31b (the thickness of the displacement layer 31c) is variable. The light extraction layer 33 faces the light guide 20.

That is, the light extraction layer 33 is disposed between the light guide 20 and the reflection layer 32. A material transmissive to visible light (e.g. an acrylic-based resin, etc.) is used for the light extraction layer 33. A material reflective to visible light (e.g. silver, aluminum, or the like) is used for the reflection layer 32. The asperity (e.g. a prism-like configuration) is provided at the interface between the light extraction layer 33 and the reflection layer 32. The light that has entered the light extraction layer 33 is reflected at the reflection layer 32, and is emitted from the light extraction layer 33.

In accordance with, for example, the voltage (electric signal) applied between the first electrode layer 31a and the second electrode layer 31b, for example, the distance between the first electrode layer 31a and the second electrode layer 31b changes by a displacement movement in accordance with the electric field applied to the displacement layer 31c. Thereby, the light extraction layer 33 can have a state of being in contact with the light guide 20 and a state of being not in contact with the light guide 20. The light guided through the light guide 20 (waveguided light L12) is propagated through the light guide 20 while being totally reflected in a portion where the light extraction layer 33 is not in contact with the light guide 20. In a portion where the light extraction layer 33 is in contact with the light guide 20, the waveguided light L12 can enter the light extraction layer 33 from the light guide 20, be reflected at the reflection layer 32, pass through the light extraction layer 33, and be emitted from the side surface 20s (in the example, the upper side surface 20a) of the light guide 20. Thus, the light extraction unit 30 can selectively emit the light guided through the light guide 20 (the waveguided light L12) toward the outside of the light guide 20 (the light L13).

The foregoing is one example of the configuration of the light extraction unit 30, and the embodiment is not limited thereto.

FIG. 3 is a schematic view illustrating one operation of the display device according to the first embodiment.

FIG. 3 illustrates the display operation in the display device 110. As shown in FIG. 3, light L11 is emitted from the light source 10. The light L11 is generated by the light source 10 being controlled by the light source driver 62. The light L11 is, for example, guided into the light guide 20 from the end surface of the second end 22 of the light guide 20. The light L11 becomes waveguided light L12 in the light guide 20. The waveguided light L12 is, for example, guided through the light guide 20 while satisfying the total reflection condition.

The scan driver 61 selects one of the plurality of light extraction units 30, and sets the light extraction unit 30 to the light extraction state (from the light guide 20). The light extraction unit 30a in the light extraction state is referred to as a “selection state light extraction unit 30a” for the sake of convenience. Of the plurality of light extraction units 30, the light extraction units 30 other than the selection state light extraction unit 30a are set in the light guide state (in the light guide 20 in accordance with the total reflection condition). The light extraction unit 30 in the light guide state is referred to as a “non-selection state light extraction unit 30b” for the sake of convenience. The non-selection state light extraction unit 30b keeps the state of the waveguided light L12 in a portion of the light guide 20 faced by the non-selection state light extraction unit 30b being the total reflection state. On the other hand, the selection state light extraction unit 30a causes the state of the waveguided light L12 in a portion of the light guide 20 faced by the selection state light extraction unit 30a to become the non-total reflection state. Thereby, the light L13 is extracted from the portion of the light guide 20 facing the selection state light extraction unit 30a to the outside of the light guide 20. The light L13 is, for example, emitted from the upper side surface 20a.

In the display operation, the first reflector 51 is set in the reflection state. Thereby, of the light guided through the light guide 20 (the waveguided light L12), a component that does not contribute to the light L13 extracted from the light guide 20 to the outside but is further guided through the light guide 20 can be reflected at the first reflector 51, be further propagated through the light guide 20, and be caused to reach the selection state light extraction unit 30a.

By the selection state light extraction unit 30a, the waveguided light L12 guided through the light guide 20 can be extracted to the outside of the light guide 20 selectively and locally.

By controlling the operation of the light source 10 and the operation of the light extraction unit 30, desired light is caused to be emitted from an arbitrary position in the X-Y plane; thereby, an arbitrary image can be formed and displayed. The plurality of light guides 20 (the side surfaces 20s) form the display surface of the display device 110.

FIG. 4 is a schematic view illustrating another operation of the display device according to the first embodiment.

FIG. 4 illustrates the power generation operation in the display device 110. When performing the power generation operation, for example, the display device 110 does not perform the display operation. As shown in FIG. 4, for example, light from the outside (external light L21) enters the light guide 20. The external light L21 is, for example, light around the display device such as sunlight. At least a part of the external light L21 is guided through the light guide 20 while satisfying the total reflection condition. For example, the state of the light extraction unit 30 is set such that the light that has entered the light guide 20 is guided through the light guide 20 in accordance with the total reflection condition in the light guide 20. Thereby, (a part of) the external light L21 that has entered the light guide 20 from the outside of the light guide 20 changes its travel direction, and becomes waveguided light L22 (a component guided) guided through the light guide 20 while satisfying the total reflection condition.

The waveguided light L22 is guided through the light guide 20 along the Y-axis direction while repeating total reflection, and is emitted from the first end 21 to become emitted light L23. The emitted light L23 passes through the first reflector 51. Furthermore, the emitted light L23 enters the light collection guide 42 via the optical path changing unit 43, and becomes waveguided light L24. The waveguided light L24 is guided through the light collection guide 42 along the X-axis direction while satisfying the total reflection condition, and enters the photoelectric conversion unit 41. Thereby, the external light L21 incident on the display surface (the light guide 20) of the display device 110 can be guided to the photoelectric conversion unit 41 with good efficiency.

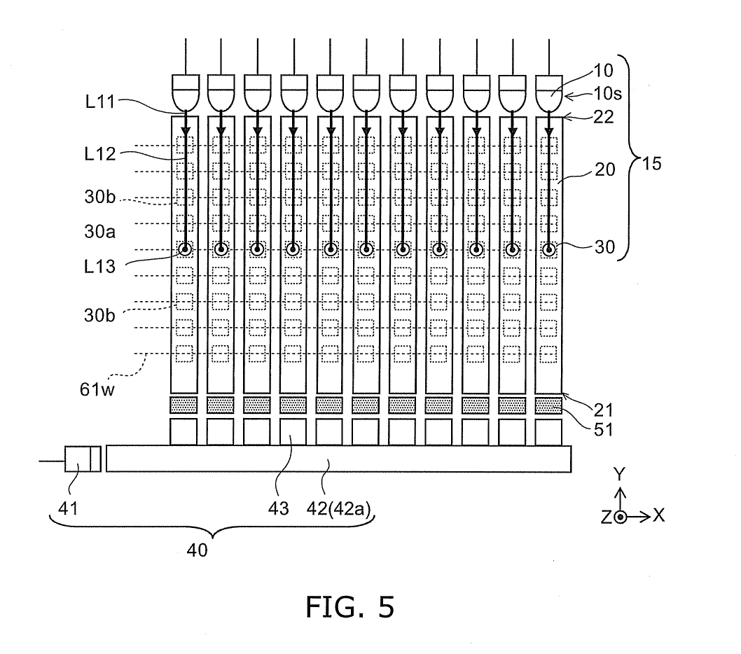

FIG. 5 is a schematic plan view illustrating an operation of the display device according to the first embodiment. FIG. 5 schematically shows the waveguide path of the light guide 20 (display region) in the display operation of the display device 110.

In the display operation, for example, line-sequential drive is performed. In the example shown in FIG. 5, scanning is performed along the Y-axis direction. Each of the plurality of scan lines 61w is connected to a plurality of light extraction units 30. The extending direction of the scan line 61w is the row direction. The scan line 61w of the i-th row (i being an integer of not less than 1 and not more than N) along the column direction from the second end 22 where the light source 10 is disposed is selected at a certain time. Thereby, the light extraction unit 30 of the i-th row is set to the light extraction state. In the example shown in FIG. 5, i=5.

At this time, the light sources 10 connected to the plurality of light guides 20 cause light L11 to be emitted with a state (including a color tone and a halftone state) with which displaying should be made in the pixels corresponding to the selection state light extraction units 30a (the positions of i=5). The light L11 becomes waveguided light L12 guided through the light guide 20, and is extracted to the outside of the light guide 20 as light L13 in the position of i=5. Thereby, a desired state (including a color tone and a halftone state) of emitted light is obtained in the light extraction unit 30 (the selection state light extraction unit 30a) in the position of i=5. By performing this operation sequentially and repeatedly from i=1 to i=N at high speed, a desired display state is obtained.

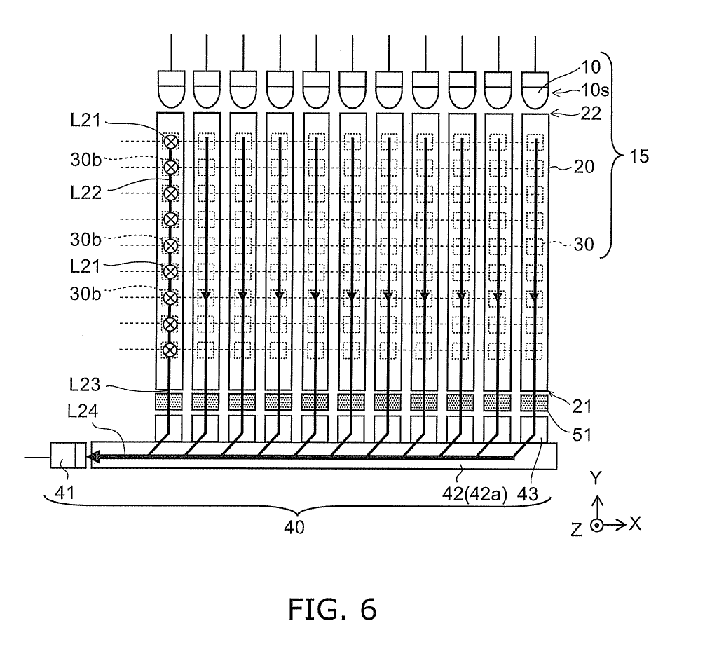

FIG. 6 is a schematic plan view illustrating another operation of the display device according to the first embodiment.

FIG. 6 schematically shows the waveguide path of the light guide 20 in the power generation operation of the display device 110.

As shown in FIG. 6, external light L21 enters the light guide 20 from the outside along the Z-axis direction. A part of the external light L21 is converted in travel direction by the light extraction unit 30, and becomes waveguided light L22. The waveguided light L22 is guided through the light guide 20 while satisfying the total reflection condition. The waveguided light L22 is emitted from the first end 21 of the light guide 20 as emitted light L23. The emitted light L23 enters the light collection guide 42 via the first reflector 51 and the optical path changing unit 43, and becomes waveguided light L24. The waveguided light L24 is guided through the light collection guide 42 while satisfying the total reflection condition, and reaches the photoelectric conversion unit 41. The optical energy is converted into electrical energy in the photoelectric conversion unit 41.

That is, the photoelectric conversion unit 41 can perform the operation of receiving the light that has entered the light guide 20 from the side surface 20s (e.g. the upper side surface 20a) of the light guide 20, is guided through the light guide 20, and is emitted from each of the first ends 21 (the emitted light L23).

Thereby, the display device 110 can perform the power generation operation in addition to the display operation. In conventional display devices, no other operation is performed when displaying is not performed. In contrast, in the display device 110, when displaying is not performed, external light L21 incident on the display surface can be converted into electrical energy with good efficiency to perform the power generation operation.

In the display device 110, by combining the light guide 20 and the light extraction unit 30, display with high reproducibility and large area can be easily provided. Furthermore, a display device having not only the display function but also the power generation function can be provided. Thus, in the embodiment, in a display device using the light guide 20, the function of power generation can be added by utilizing the light guide properties of the light guide 20. The embodiment can provide a display device with high performance and high functionality.

In the display device 110, one display element including the light source 10, the light guide 20, and the light extraction units 30 extends along the Y-axis direction. A plurality of display elements are disposed along the X-axis direction. Thereby, by increasing the number of display elements, a large-area display device can be relatively easily obtained. Such a large-area display device is particularly suitable for outdoor installation, and having the power generation function is particularly effective.

However, the embodiment is not limited thereto; and the size of the display surface of the display device 110 is arbitrary, and the display device 110 may be installed indoors or portable equipment.

Furthermore, in the power generation operation in the display device 110 in the example, external light L21 entering the plurality of light guides 20 is collected to the light collection guide 42 and guided to the photoelectric conversion unit 41. That is, for example, the external light L21 incident on the entire surfaces of the plurality of light guides 20 that form the display surface is caused to be guided through the light guides 20 by the plurality of light extraction units 30. Furthermore, the light is caused to be guided through the light collection guide 42, where the light is collected and guided to the photoelectric conversion unit 41. Thereby, the efficiency of converting the external light L21 into electrical energy is enhanced.

That is, in the display device 110, the size of the light receiving surface of the photoelectric conversion unit 41 can be made smaller than the size of the display surface. A device with high photoelectric conversion efficiency, for example, may be used as the photoelectric conversion unit 41.

In general, in photoelectric conversion devices such as solar cells, for example, the electricity output is increased by increasing the area with which external light is incident. For example, also in a configuration in which a solar cell is provided on the display surface or back surface of a display device, design is made so as to increase the area with which external light is incident on the solar cell.

In contrast, in the display device 110 according to the embodiment, a light collection function is obtained by a configuration using the light guide 20 and the light receiver 40 including the light collection guide 42. Thereby, a device that has high efficiency but is difficult to increase in area such as, for example, a device using a single crystal is easily used as the photoelectric conversion unit 41. Thus, in the embodiment, the photoelectric conversion unit 41 can contain a single-crystal semiconductor. Thereby, high power generation efficiency is easily obtained.

In the display device 110, in the plurality of pixels arranged in a matrix configuration, an optical signal utilizing light waveguiding is obtained based on an electric signal. In the display device 110, a mechanism of guiding light (e.g. the plurality of light guides 20) is provided at the display surface. In the embodiment, a waveguide path based on the configuration is used not only for the display operation but also for the light collection operation of external light L21. That is, a composing element for the display operation (e.g. the light guide 20) is used also for the operation of power generation. Thereby, the display device can be provided with a power generation function by a small number of members.

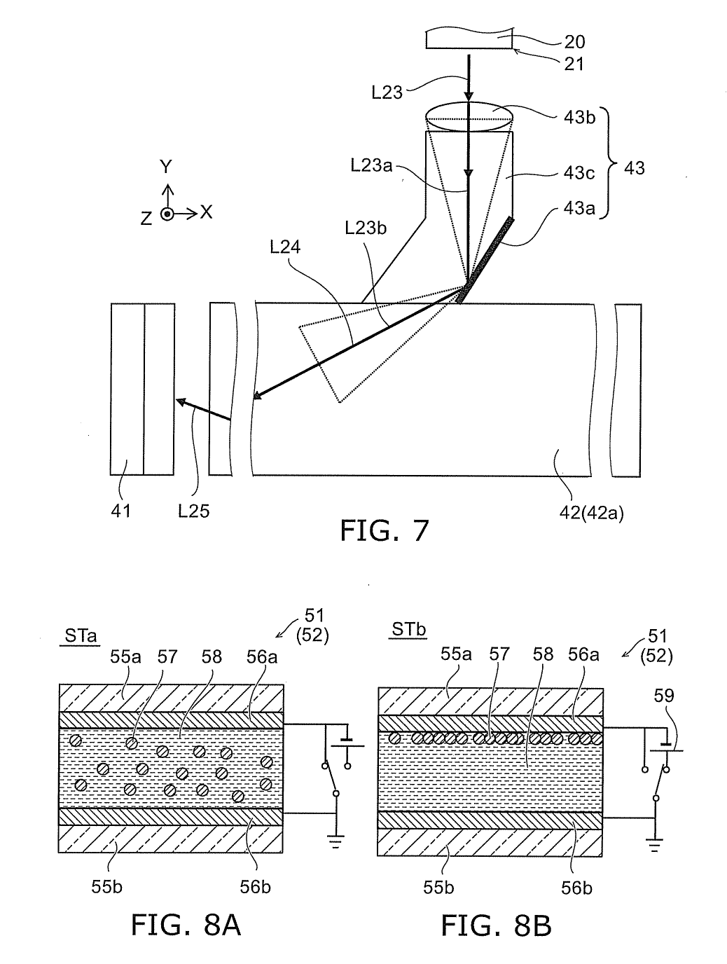

FIG. 7 is a schematic view illustrating the configuration of a part of the display device according to the first embodiment.

FIG. 7 illustrates the configuration of the optical path changing unit 43 that can be used for the light receiver 40 of the display device 110. A plurality of optical path changing units 43 are provided in the light receiver 40. FIG. 7 illustrates the configuration of one optical path changing unit 43. In FIG. 7, the first reflector 51 is omitted.

As shown in FIG. 7, the optical path changing unit 43 further includes a reflection layer 43a. That is, the optical path changing units 43 include a plurality of reflection layers 43a, and each of the plurality of reflection layers 43a is provided to correspond to each of the plurality of light guides 20. Each of the plurality of reflection layers 43a is juxtaposed to each of the first ends 21 of the plurality of light guides 20. Each of the plurality of reflection layers 43a reflects the light emitted from each of the first ends 21 of the plurality of light guides 20 (e.g. emitted light L23), and causes the light to enter the light collection guide 42.

In the example, the optical path changing unit 43 further includes an optical path changing light guide body 43c. The optical path changing light guide body 43c includes an inclined surface inclined with respect to the Y-axis direction, and the reflection layer 43a is provided on the inclined surface. The emitted light L23 enters the optical path changing light guide body 43c from one end of the optical path changing light guide body 43c, and the light is reflected at the reflection layer 43a and enters the light collection guide 42.

As shown in FIG. 7, in the example, a condensing lens 43b is provided in one optical path changing unit 43. That is, the optical path changing units 43 further include a plurality of condensing lenses 43b. Each of the plurality of condensing lenses 43b faces each of the first ends 21 of the plurality of light guides 20. The light L23a condensed in each of the plurality of condensing lenses 43b is incident on each of the plurality of reflection layers 43a.

A material transmissive to visible light such as a resin and glass is used for the optical path changing light guide body 43c. A material excellent in transmissivity at wavelengths in at least the visible light range is used for the optical path changing light guide body 43c.

The light L23a is reflected at the reflection layer 43a in accordance with the inclination angle of the reflection layer 43a. The light L23b obtained by the reflection at the reflection layer 43a enters the light collection guide 42. The incident angle of the light L23b to the light collection guide 42 is set to an angle suitable for the waveguided light L24 to be guided through the light collection guide 42 while satisfying the total reflection condition.

The optical path changing light guide body 43c is optically connected to the light collection guide 42. The light that has reached the light collection guide 42 (the waveguided light L24) is guided through the light collection guide 42, and reaches the photoelectric conversion unit 41 as light L25.

The example is one example of the optical path changing unit 43, and the embodiment is not limited thereto. In the embodiment, the configuration of the light receiver 40 is arbitrary to the extent that the light receiver 40 has a configuration in which the emitted light L23 emitted from the light guide 20 is guided to the photoelectric conversion unit 41 with good efficiency (for example, by guiding light while satisfying the total reflection condition).

FIG. 8A and FIG. 8B are schematic views illustrating the configuration and operations of a part of the display device according the first embodiment.

The drawings illustrate the configuration and operations of the first reflector 51 of the display device 110. The configuration illustrated in the drawings can be applied also to a second reflector described later.

As shown in FIG. 8A and FIG. 8B, the first reflector 51 includes a first electrode 56a, a second electrode 56b, and a fluid layer 58. The fluid layer 58 is provided between the first electrode 56a and the second electrode 56b. The fluid layer 58 contains mobile ions 57. A silver ion and the like, for example, are used as the mobile ion 57 contained in the fluid layer 58. The first electrode 56a and the second electrode 56b are transmissive to visible light.

In the example, the first electrode 56a is provided on the major surface of a first substrate 55a. The second electrode 56b is provided on the major surface of a second substrate 55b. The first substrate 55a and the second substrate 55b are transmissive to visible light. The transmissivity in the visible light range of the first substrate 55a and the second substrate 55b is high. The embodiment is not limited thereto. For example, the first electrode 56a may be provided on the end surface of the first end 21 of the light guide 20.

FIG. 8A illustrates a first state STa of the first reflector 51. FIG. 8B illustrates a second state STb of the first reflector 51.

As shown in FIG. 8A, in the first state STa, for example, the electric potential of the first electrode 56a is set equal to the electric potential of the second electrode 56b (e.g. the ground potential). In this case, the mobile ions 57 are in a state of being scattered in the fluid layer 58. Therefore, light (light of wavelengths in the visible light range) can be transmitted through the first reflector 51. That is, a transmission state is formed in the first state STa.

As shown in FIG. 8B, in the second state STb, the first electrode 56a is electrically connected to one end of a power source 59, and the second electrode 56b is electrically connected to the other end of the power source 59. Thereby, a voltage is applied to the fluid layer 58. By the potential difference applied to the fluid layer 58, mobile ions 57 (silver ions etc.) migrate toward one electrode (in the example, the first electrode 56a). Then, mobile ions 57 are deposited on the surface of the first electrode 56a. Thereby, a reflection surface based on the properties of silver of the mobile ions 57 is formed.

A reflection state is formed in the second state STb.

Thus, the reflection state (the second state STb) and the transmission state (the first state STa) are obtained in the first reflector 51. That is, the light reflectance of the first reflector 51 is variable.

The configuration mentioned above is one example of the first reflector 51, and the embodiment is not limited thereto. In the embodiment, the configuration of the first reflector 51 is arbitrary to the extent that the light reflectance is variable and the reflection state and the transmission state are obtained.

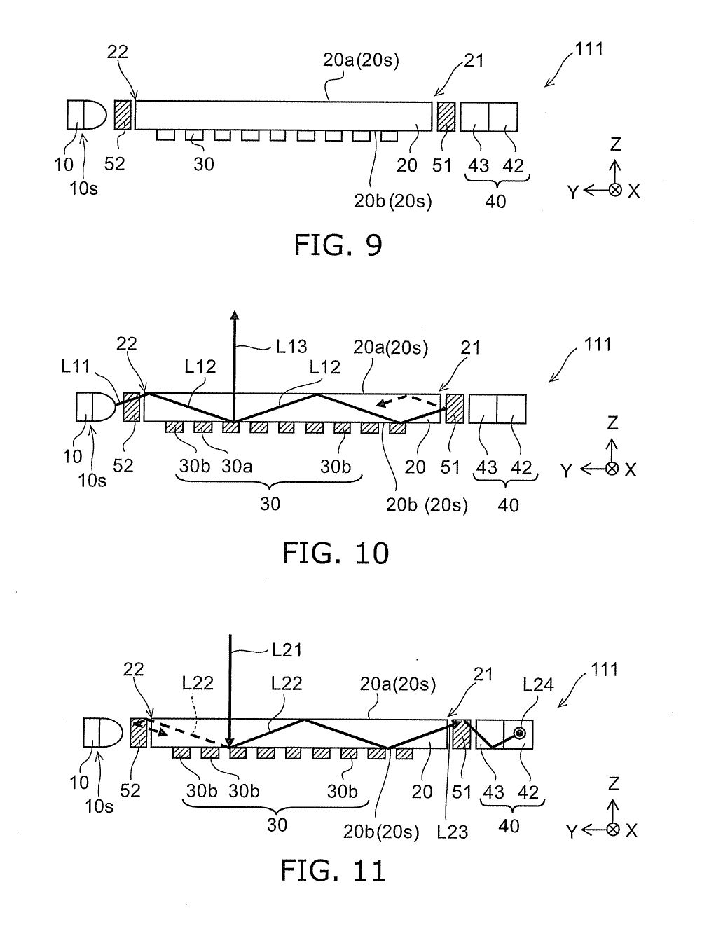

FIG. 9 is a schematic cross-sectional view illustrating the configuration of another display device according to the first embodiment.

FIG. 9 illustrates, the configuration of another display device 111 according to the embodiment, and is a cross-sectional view corresponding to the cross section taken along line A1-A2 of FIG. 1A. Portions different from the configuration of the display device 110 will now be described in regard to the configuration of the display device 111.

As shown in FIG. 9, the display device 111 further includes a second reflector 52, in addition to the plurality of light emitting units 10s (e.g. the light sources 10), the plurality of light guides 20, the plurality of light extraction units 30, the light receiver 40, and the first reflectors 51.

The second reflector 52 is provided to face each of the second ends 22 of the plurality of light guides 20. That is, a plurality of second reflectors 52 are provided, and each of the plurality of second reflectors 52 faces each of the second ends 22. In the example, the second reflector 52 faces the end surface of the second end 22. The light reflectance of the second reflector 52 is variable.

The second reflector 52 can perform the operation of reflecting the light incident on the second reflector 52 (a reflection operation) and the operation of transmitting the light incident on the second reflector 52 (a transmission operation). The configuration described in regard to FIG. 8A and FIG. 8B may be used for the second reflector 52.

For example, the second reflectors 52 reflect the light emitted from the second ends 22 of the light guides 20 and causes the light to enter the plurality of light guides 20. The second reflector 52 transmits the light emitted from the light source 10, and causes the light to enter the light guide 20 from the second end 22.

FIG. 10 is a schematic view illustrating one operation of the other display device according to the first embodiment. FIG. 10 illustrates the display operation in the display device 111. In the display operation, for example, the second reflector 52 is set in the transmission state, and the first reflector 51 is set in the reflection state.

As shown in FIG. 10, light L11 is emitted from the light source 10. The light L11 passes through the second reflector 52, and is guided into the light guide 20 from the end surface of the second end 22 of the light guide 20. The light L11 becomes waveguided light L12 in the light guide 20. The waveguided light L12 is guided through the light guide 20 while satisfying the total reflection condition. The waveguided light L12 is extracted from the light guide 20 to the outside by the selection state light extraction unit 30a. That is, from a prescribed position, light L13 is emitted from the light guide 20.

At this time, in the waveguided light L12, a component may occur that is not extracted from the light guide 20 to the outside in the position of the selection state light extraction unit 30a but further guided forward through the light guide 20. The component is further guided through the light guide 20 while satisfying the total reflection condition, and reaches the first end 21. The component is reflected (e.g. specularly reflected) at the first reflector 51. That is, a part of the waveguided light L12 is reflected at the first end 21 to turn back in the light guide 20, and is guided through the light guide 20. The light reaches the selection state light extraction unit 30a in a prescribed position, and is emitted to the outside of the light guide 20.

Thus, by using two reflectors (the first reflector 51 and the second reflector 52), the proportion of the quantity of light emitted (released) to the outside of the light guide 20 to the quantity of light introduced into the light guide 20 from the light source 10 can be increased.

FIG. 11 is a schematic view illustrating another operation of the other display device according to the first embodiment.

FIG. 11 illustrates the power generation operation in the display device 111. In the power generation operation, the second reflector 52 is set in the reflection state, and the first reflector 51 is set in the transmission state.

The external light L21 (or a part thereof) entering the light guide 20 from the outside of the display surface (the light guide 20) reaches the light extraction unit 30 via the light guide 20. The light is changed in travel direction to become waveguided light L22. The waveguided light L22 is guided through the light guide 20 while satisfying the total reflection condition. A part of the waveguided light L22 passes through the first reflector 51, and reaches the light collection guide 42 of the light receiver 40. On the other hand, another part of the waveguided light L22 is reflected at the second reflector 52 to enter the light guide 20 again, and is guided through the light guide 20 to reach the light collection guide 42 via the first reflector 51. These rays of light that have reached the light collection guide 42 enter the photoelectric conversion unit 41 with good efficiency.

Thus, by using two reflectors (the first reflector 51 and the second reflector 52), also in the power generation operation, the waveguided light L22 can be guided to the light collection guide 42 with good efficiency. Thereby, the external light L21 entering the light guide 20 can be caused to reach the photoelectric conversion unit 41 with good efficiency. As a consequence, the amount of electrical energy obtained can be increased, and power generation efficiency is improved.

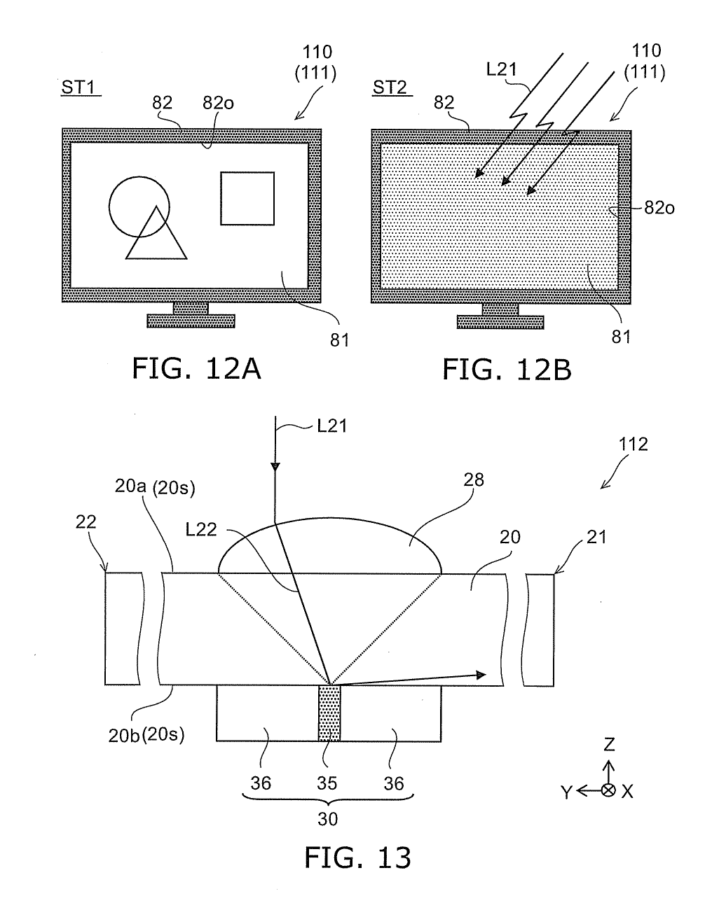

FIG. 12A and FIG. 12B are schematic view illustrating operations of the display device according to the first embodiment.

The drawings illustrate two operating states of the display device according to the embodiment (e.g. the display device 110, the display device 111, modifications thereof, etc.). FIG. 12A corresponds to the display operation (a display state

ST1), and FIG. 12B corresponds to the power generation operation (a power generation state ST2). In the following, an example in regard to the display device 110 is described.

As shown in FIG. 12A, in the display device 110, a cabinet 82 including an opening 82o is provided, and a display region 81 is disposed in the opening 82o. As described above, the display region 81 is a region where the plurality of light guides 20 (not shown in the drawing) and the plurality of light extraction units 30 (not shown in the drawing) face each other. In the display state ST1, the operation mentioned above is performed, and arbitrary display information is displayed in the display region 81.

As shown in FIG. 12B, in the power generation state ST2, external light L21 enters the plurality of light guides 20 (not shown in the drawing) of the display region 81. That is, the display region 81 functions as a light collection unit of the external light L21 incident on the display region 81.

Thus, the display device 110 (and 111 etc.) according to the embodiment can be used as a display device in which display information is sighted by an observer in the display operation (the display state ST1), and can be used as a power generation device utilizing the external light L21 incident on the display region 81 in the non-display operation (the power generation state ST2). In particular, when the display device 110 (and 111 etc.) is used for a public display etc. installed outdoors, the power generation operation can be made to be performed in the non-display operation, and electrical energy necessary in the display operation can be stored in, for example, the electricity storage unit 72 to contribute to power consumption reduction.

For example, at least a part of the electrical energy stored in the electricity storage unit 72 can be supplied to the power supply 64.

FIG. 13 is a schematic cross-sectional view illustrating the configuration of a part of another display device according to the first embodiment.

FIG. 13 is a cross-sectional view corresponding to the cross section taken along line A1-A2 of FIG. 1A.

FIG. 13 illustrates an enlarged view of a part of the light guide 20 of another display device 112 according to the embodiment. The portions other than the portion illustrated in

FIG. 13 may be similar to those of the display device 110 or the display device 111, and a description is therefore omitted.

As shown in FIG. 13, the display device 112 further includes a plurality of lenses (light guide lenses 28). The plurality of light extraction units 30 are provided. FIG. 13 illustrates enlarged views of one light guide lens 28 and one light extraction unit 30.

The plurality of light extraction units 30 are disposed along the Y-axis direction and face the side surfaces 20s (e.g. the lower side surfaces 20b) of the plurality of light guides 20. The light guide 20 is disposed between each of the plurality of light guide lenses 28 and each of the plurality of light extraction units 30.

As shown in FIG. 13, two or more regions are provided in the light extraction unit 30. For example, the light extraction unit 30 includes a first region 35 in which the light guide lens 28 focuses and a second region 36 other than the first region 35. The light guided from the outside through the light guide 20 to the light extraction unit 30 is mainly collected to the first region 35. For example, in the first region 35, the prism configuration formed between the light extraction layer 33 and the reflection layer 32 described in regard to FIG. 2 is made a configuration suitable for external light to be guided through the light guide 20. Thereby, the quantity of light reaching the light receiver 40 can be increased. That is, in the first region 35, the prism angle may be set such that the total reflection angle in the light guide 20 is shallow for the main incident angle of the external light reaching the light extraction unit 30. In the second region 36, the prism configuration may be set such that the light guided from the light source 10 is easily emitted to the outside. That is, for example, in the case where the waveguided light from the light source 10 is guided with an angle near the total reflection angle, the prism configuration may be set so as to convert the travel direction of light to the Z-axis direction. Thereby, by utilizing the focus position due to the lens effect, light can be emitted and collected with good efficiency in both the light extraction operation and the light collection operation.

### Second Embodiment

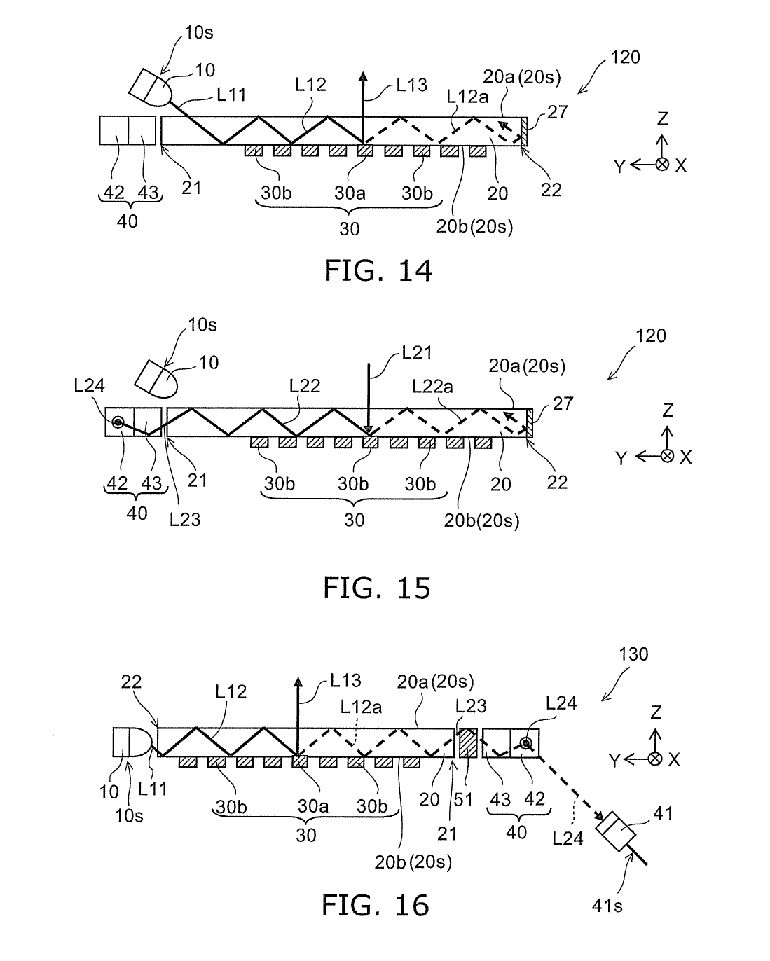

FIG. 14 is a schematic cross-sectional view illustrating the configuration and one operation of a display device according to a second embodiment.

FIG. 14 illustrates the configuration of a display device 120 according to the embodiment. Of the configuration of the display device 120, the portions other than the portion illustrated in FIG. 14 may be similar to those of the display device 110 or the display device 111, and a description is therefore omitted.

As shown in FIG. 14, also the display device 120 according to the embodiment includes the plurality of light emitting units 10s (e.g. the light sources 10), the plurality of light guides 20, the plurality of light extraction units 30, and the light receiver 40. In the example, the light source 10 and the light receiver 40 are juxtaposed to the first end 21 of the light guide 20. The light receiver 40 faces the first end 21 (specifically, the end surface of the first end 21). The light source 10 causes light L11 to enter the light guide 20 from a portion on the first end 21 side of the light guide 20. In the example, the light source 10 causes light L11 to enter the light guide 20 from the side surface 20s (the upper side surface 20a) near the first end 21. Thus, the light source 10 and the light receiver 40 (the light collection guide 42) are disposed at a common end of the light guide unit 20.

The display device 120 further includes a light reflection layer 27 provided to face the second end 22 of the light guide 20. The light reflection layer 27 is formed by, for example, forming a reflection film on the end surface of the second end 22. A silver film formed by the vacuum deposition method, for example, may be used as the light reflection layer 27.

In the example, the light source 10 emits light with high directivity (light L11). The light L11 enters the light guide 20 with an inclination with respect to the extending direction of the light guide 20 (the Y-axis direction). The inclination angle of the light L11 (e.g. the angle between the Z-axis direction and the light L11) is set such that the angle of the waveguided light L12 in the light guide 20 is a value near the total reflection angle when the light L11 enters the light guide 20.

Thus, in the display device 120, the light source 10 is disposed not to face the end surface of the light guide 20 but to face the end (the first end 21) near the side surface 20s. By the configuration, the light source 10 and the light receiver 40 (the light collection guide 42) can be installed at the same (common) end.

In the display device 120, the photoelectric conversion unit 41 (not shown in FIG. 14) is disposed on the first end 21 side.

FIG. 14 illustrates also the display operation in the display device 120. As shown in FIG. 14, light L11 is emitted from the light source 10. The light L11 is guided into the light guide 20 from the side surface 20s (e.g. the upper side surface 20a) near the first end 21 of the light guide 20. The waveguided light L12 is guided through the light guide 20 while satisfying the total reflection condition. Also in this case, the light extraction unit 30 (the selection state light extraction unit 30a) in a desired position is set to the light extraction state, and light L13 is extracted to the outside of the light guide 20. The light L13 is emitted from, for example, the upper side surface 20a. A part of the light L11 becomes waveguided light L12a (the broken line in FIG. 14); and the waveguided light L12a reaches the second end 22 to be reflected (e.g. specularly reflected) at the light reflection layer 27, and is guided through the light guide 20 toward the first end 21. The waveguided light L12a reaches the selection state light extraction unit 30a; and the optical path of a part of the waveguided light L12a is changed by the selection state light extraction unit 30a, and the part of the waveguided light L12a is extracted to the outside of the light guide 20 as light L13.

FIG. 15 is a schematic view illustrating another operation of the display device according to the second embodiment.

FIG. 15 illustrates the power generation operation in the display device 120. When performing the power generation operation, for example, the display device 120 does not perform the display operation. As shown in FIG. 15, for example, external light L21 (e.g. sunlight) enters the light guide 20. A part of the external light L21 is guided through the light guide while satisfying the total reflection condition. The waveguided light L22 is guided through the light guide 20 along the Y-axis direction while repeating total reflection, and is emitted from the first end 21 to become emitted light L23. Another part of the external light L21 becomes waveguided light L22a (the broken line in FIG. 15); and the waveguided light L22a is reflected (e.g. specularly reflected) at the light reflection layer 27 to be guided through the light guide 20 again, and is emitted from the first end 21 to become emitted light L23. These rays of emitted light L23 enter the light collection guide 42 via the optical path changing unit 43, and become waveguided light L24. The waveguided light L24 enters the photoelectric conversion unit 41. Thereby, the external light L21 incident on the display surface (the light guide 20) of the display device 120 can be guided to the photoelectric conversion unit 41 with good efficiency.

In the display device 120, the proportion of the amount of optical energy of extracted light (light L13) to the amount of energy of light L11 emitted from the light source 10 can be increased. In the display device 120, the proportion of external light L21 reaching the photoelectric conversion unit 41 can be increased, and thereby the efficiency of photoelectric conversion can be improved. Furthermore, in the display device 120, since the light source 10 and the light receiver 40 are disposed at a common end (the first end 21) of the light guide 20, device configuration can be simplified. Thereby, the flexibility of planning and design is increased. Furthermore, the weight can be reduced and the eternal shape can be easily downsized.

### Third Embodiment

FIG. 16 is a schematic cross-sectional view illustrating the configuration and operations of a display device according to a third embodiment.

FIG. 16 illustrates the configuration of a display device 130 according to the embodiment. In the configuration of the display device 130, the portions other that the portion illustrated in FIG. 16 may be similar to those of the display devices 110, 111, 112, and 120, and a description is therefore omitted.

As shown in FIG. 16, also the display device 130 according to the embodiment includes the plurality of light emitting units 10s (e.g. the light sources 10), the plurality of light guides 20, the light extraction units 30, and the light receiver 40. In the example, the light receiver 40 is juxtaposed to the first end 21, and the light source 10 is juxtaposed to the second end 22. However, the light source 10 and the light receiver 40 may also be juxtaposed to the first end 21. In the following, the case is described where the light receiver 40 is juxtaposed to the first end 21 and the light source 10 is juxtaposed to the second end 22. In the example, the first reflector 51 is provided between the first end 21 and the light receiver 40.

In the display device 130, the photoelectric conversion unit 41 is not used as a power generation function unit, but the photoelectric conversion unit 41 is used as a detection function unit of the quantity of light reaching the photoelectric conversion unit 41. The detection can be, for example, also performed in real time. Based on the detection result of the quantity of light reaching the photoelectric conversion unit 41, for example, the change over time in the quantity of light of the light source 10 and the quantity of light emitted from the light extraction unit 30 can be estimated. The operation of at least one of the light source 10 and the light extraction unit 30 may be controlled based on the estimation.

FIG. 16 illustrates an example of the detection operation of detecting the quantity of light. In this case, the first reflector 51 is set in the transmission state. As shown in FIG. 16, the light L11 emitted from the light source 10 becomes waveguided light L12. The waveguided light L12 is guided through the light guide 20 while satisfying the total reflection condition. A part of the waveguided light L12 is emitted to the outside of the light guide 20 as light L13 by the selection state light extraction unit 30a. The light not emitted to the outside out of the waveguided light L12 is guided as waveguided light L12a through the light guide 20 toward the first end 21 while satisfying the total reflection condition. The waveguided light L12a is emitted from the first end 21, and the emitted light L23 enters the light collection guide 42 via the first reflector 51 and the optical path changing unit 43. The waveguided light L24 is guided through the light collection guide 42, and reaches the photoelectric conversion unit 41. The waveguided light L24 is converted into an electric signal by the photoelectric conversion unit 41.

All the light extraction units 30 are set in the state of the non-selection state light extraction unit 30b, for example. Thereby, for example, all the light that has entered the light guide 20 reaches the photoelectric conversion unit 41, except for the loss in the optical path (e.g. the loss due to scattering etc. in the inside of the light guide 20 etc.). Thereby, for example, the change over time in the quantity of light in the light source 10 etc. can be detected in real time.

In the case where the selection state light extraction unit 30a exists among the plurality of light extraction units 30, the difference (e.g. the change amount) in regard to the quantity of light emitted to the outside of the light guide 20 by the selection state light extraction unit 30a etc. can be detected and estimated in real time.

For example, the controller 71 can detect the difference between the quantity of light guided through the light guide 20 and reaching the photoelectric conversion unit 41 out of the light L11 emitted from the light emitting unit 10s (the light source 10) and the quantity of light of light L13 emitted from the light guide 20 to the outside of the light guide 20 by the light extraction unit 30. For example, the controller 71 can detect the difference between the quantity of light guided through the light guide 20 and reaching the photoelectric conversion unit 41 out of the light emitted from the light emitting unit 10s when at least one of the light extraction units 30 is in the light extraction state (when the light guided through the light guide 20 is emitted toward the outside of the light guide) and the quantity of light guided through the light guide 20 and reaching the photoelectric conversion unit 41 out of the light emitted from the light emitting unit 10s when the at least one light extraction unit 30 mentioned above is in the light guide state (when the light guided through the light guide 20 is not emitted toward the outside of the light guide 20). The controller 71 can output the detection result. By the output of the controller 71, for example, information in regard to the change in the display function can be obtained.

For example, in the light extraction unit 30 of the i-th (i=1 to N), the quantities of light reaching the photoelectric conversion unit 41 in the light extraction state and in the light guide state are detected, and the difference between them is found. Furthermore, for example, in the light extraction unit 30 of the j-th (j=1 to N, j being different from i), the quantities of light reaching the photoelectric conversion unit 41 in the light extraction state and in the light guide state are detected, and the difference between them is found. Also these differences may be compared. By the comparison, the difference between the characteristics of the light extraction unit 30 of the i-th and the characteristics of the light extraction unit 30 of the j-th can be detected.

The operations of the light emitting unit 10s (e.g. the light source 10) and the light extraction unit 30 may be controlled in accordance with various detection results like the above. That is, the display device 130 may include a circuit unit (at least one of the scan driver 61 and the light source driver 62) that supplies an electric signal to at least one of the light emitting unit 10s (e.g. the light source 10) and the light extraction unit 30. The photoelectric conversion unit 41 converts the light emitted from the light emitting unit 10s (the light source 10) and guided through the light guide 20 (the waveguided light L12a) to produce an electrical monitor signal (output 41s). The circuit unit can change the electric signal supplied to at least one of the light source 10 and the light extraction unit 30 in accordance with the monitor signal.

Thereby, the operations of the light source 10 and the light extraction unit 30 can be appropriately controlled while being related to the change over time of the light source 10 and the variation of the operation of the light extraction unit 30 etc. Thereby, for example, uniform display with high reliability can be provided.

The detection function like the above is useful for maintaining image quality in the display operation etc. By the display device 130, the change in the characteristics of the elements included in the display device 130 can be detected without additionally providing any device for detecting a variation in light quantity etc. The detection can be performed in real time and detection accuracy can be more improved, for example.

The embodiment provides a display device with high performance and high functionality.

Hereinabove, embodiments of the invention are described with reference to specific examples. However, the embodiment of the invention is not limited to these specific examples. For example, one skilled in the art may appropriately select specific configurations of components of display devices such as light sources, light guides, light extraction units, light receivers, photoelectric conversion units, light collection guides, optical path changing units, and reflectors from known art and similarly practice the invention. Such practice is included in the scope of the invention to the extent that similar effects thereto are obtained.

Further, any two or more components of the specific examples may be combined within the extent of technical feasibility; and such combinations are included in the scope of the invention to the extent that the spirit of the invention is included.

Moreover, all display devices that can be obtained by an appropriate design modification by one skilled in the art based on the display devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A display device comprising:
a plurality of light emitting units to emit a light;
a plurality of light guides to guide the light emitted from the light emitting units, each of the light guides including a side surface extending along a first direction, a first end, and a second end, the light guides being disposed in a second direction intersecting the first direction;
a plurality of light extraction units, each of the light extraction units facing the side surface of the light guides and being capable of selectively emitting a light which is guided through the light guides toward an outside of the light guides; and
a light receiver facing the first end and including a photoelectric conversion unit configured to receive a light which is guided through each of the light guides and is emitted from the first end.

2. The device according to claim 1, further comprising a first reflector provided between the first end of each of the light guides and the light receiver, a light reflectance of the first reflector being variable,
the first reflector being capable of performing an operation of reflecting a light incident on the first reflector and an operation of transmitting a light incident on the first reflector.

3. The device according to claim 1, further comprising a second reflector facing the second end of each of the light guides, a light reflectance of the second reflector being variable,
the second reflector being capable of performing an operation of reflecting a light incident on the second reflector and an operation of transmitting a light incident on the second reflector.

4. The device according to claim 1, wherein the light receiver further includes a light collection guide configured to guide the light emitted from the first end and cause the light to enter the photoelectric conversion unit.

5. The device according to claim 4, wherein the light receiver further includes an optical path changing unit facing the first end and configured to change an optical path of the light emitted from the first end and cause the light to enter the light collection guide.

6. The device according to claim 5, wherein
the optical path changing unit further includes a plurality of reflection layers,
each of the reflection layers is juxtaposed to the first end of each of the light guides, and
each of the reflection layers reflects the light emitted from the first end of each of the light guides to cause the light to enter the light collection guide.

7. The device according to claim 6, wherein
the optical path changing unit further includes a plurality of condensing lenses,
the condensing lenses face the first end of each of the light guides, and
a light condensed in the condensing lenses is incident on the reflection layers.

8. The device according to claim 1, wherein the photoelectric conversion unit is capable of performing an operation of receiving the light emitted from the first end and converting the received light into electrical energy.

9. The device according to claim 1, wherein the photoelectric conversion unit is capable of performing an operation of receiving the light which enters each of the light guides from the side surface of each of the light guides, is guided through each of the light guides, and is emitted from the first end, and an operation of converting the received light into electrical energy.

10. The device according to claim 8, further comprising:
an electricity storage unit to store the electrical energy; and
a controller to control supply of the electrical energy from the photoelectric conversion unit to the electricity storage unit or extraction of the electrical energy from the electricity storage unit.

11. The device according to claim 1, further comprising a controller to detect a difference between
a quantity of a light which is guided through the light guides and reaches the photoelectric conversion unit out of the light emitted from the light emitting units when at least one of the light extraction units emits the light being guided through the light guides toward an outside of the light guides and
a quantity of a light which is guided through the light guides and reaches the photoelectric conversion unit out of the light emitted from the light emitting units when the at least one of the light extraction units does not emit the light being guided through the light guides toward an outside of the light guides and
to output a result of the detection.

12. The device according to claim 1, further comprising a circuit unit to supply an electric signal to at least one of the light emitting units and the light extraction units,
the photoelectric conversion unit being configured to convert the light emitted from the light emitting units and guided through the light guides to produce an electrical monitor signal,
the circuit unit being configured to change the electric signal in accordance with the monitor signal.

13. The device according to claim 1, wherein each of the light emitting units causes a light to enter each of the light guides from the second end.

14. The device according to claim 1, wherein each of the light emitting units causes a light to enter each of the light guides from the first end.

15. The device according to claim 1, wherein the photoelectric converter includes a single crystalline semiconductor.

16. The device according to claim 1, further comprising:
a circuit unit to supply an electric signal to at least one of the light emitting units and the light extraction units; and
a power supply to supply a current to the circuit unit,
at least a part of an electrical energy obtained by converting a light received by the photoelectric converting unit being supplied to the power supply.

17. The device according to claim 1, wherein the light extraction units change a light guide state of the light in the light guides between a total reflection state and a non-total refelction state.

18. The device according to claim 1, wherein the light extraction units include a liquid crystal device or a Micro Electro Mechanical System device.

19. The device according to claim 1, wherein each of the light emitting units includes a semiconductor light emitting device.

20. The device according to claim 1, wherein the light emitted from the light emitting units has a wavelength not less than 400 nanometers and not more than 760 nanometers.
